(19) United States
(12) Patent Application Publication
(10) Pub. No.: US 2015/0282470 A1
(43) Pub. Date: Oct. 8, 2015

(54) AQUATIC MATERIAL APPLICATION SYSTEM

(71) Applicant: THOMAS JOHN MCNABB, Coeur D'Alene, ID (US)

(72) Inventor: THOMAS JOHN MCNABB, Coeur D'Alene, ID (US)

(21) Appl. No.: 14/243,091

(22) Filed: Apr. 2, 2014

(51) Int. Cl. A01M 21/04

(52) U.S. Cl. CPC A01M 21/04

(57) ABSTRACT

An aquatic material application system is configured to disperse material on vegetation beneath water. The aquatic material application system includes a vessel that is configured to float upon the water. A propulsion system is attached to the vessel and configured to propel the vessel through the water. A cooling system is attached to the vessel and configured to pump the material, cool the material creating a cooled material and then dispense the cooled material from the vessel. The cooled material is configured to sink through the water to contact the vegetation.

### BACKGROUND

The embodiments herein relate generally to systems configured to apply herbicide in a marine environment.

Prior to embodiments of the disclosed invention, technology for the subsurface application of liquid or granular pesticides, nutrient inactivation, and/or water quality improvement compounds is surface injection, granular spreaders, and the use of weighted and trailing hoses deployed from a vessel. Surface injection of these compounds below the thermocline, or to the bottom of a water body in sufficient concentrations to control the target pest, to deactivate nutrients, and or enhance water quality is presently required in the industry. The current technology that utilizes weighted or trailing hoses. This results in a cumbersome, slow process that allows for the application of these compounds, but only when the vessel travels at approximately 2-5 miles per hour.

Embodiments of the disclosed invention solve these problems.

### SUMMARY

An aquatic material application system is configured to disperse material on vegetation beneath water. The aquatic material application system includes a vessel that is configured to float upon the water. A propulsion system is attached to the vessel and configured to propel the vessel through the water. A cooling system is attached to the vessel and configured to pump the material, cool the material creating a cooled material and then dispense the cooled material from the vessel. The cooled material is configured to sink through the water to contact the vegetation.

In some embodiments, the cooling system includes a first tank that is configured to store the material. A pump is mechanically coupled to the first tank. A first cooler is mechanically coupled to the pump. A first nozzle mechanically coupled to the first cooler. The pump is configured to move the material from the first tank through the first cooler creating the cooled material, which is dispensed through the first nozzle.

In some embodiments, the cooling system includes a second tank that is configured to store the material. The pump is mechanically coupled to the second tank. A second cooler is mechanically coupled to the pump. A second nozzle is mechanically coupled to the second cooler. The pump is configured to move the material from the second tank through the second cooler creating the cooled material, which is dispensed through the first nozzle.

In some embodiments, the material includes one of: a liquid or granular pesticides, a nutrient inactivation, and a water quality improvement compound. In some embodiments, cooler utilizes dry ice. In other embodiments, the cooler utilizes liquid nitrogen.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic side elevation view of an embodiment of the invention.

FIG. 2 shows a schematic top plan view of an embodiment of the invention.

### DETAILED DESCRIPTION OF CERTAIN EMBODIMENTS

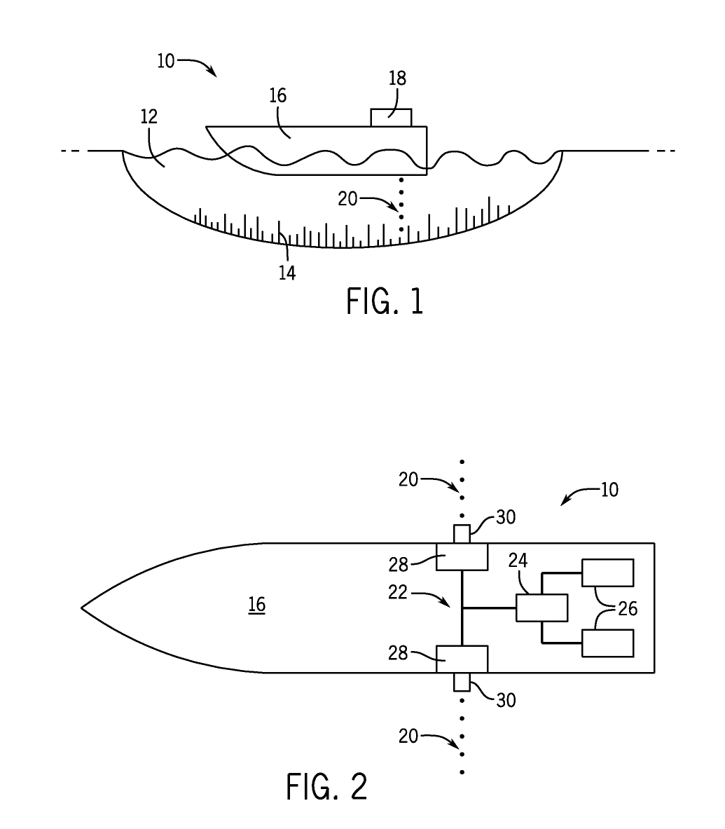

By way of example, and referring to FIG. 1, one embodiment of aquatic material application system 10 is configured to apply material 20 onto vegetation 14 at the bottom of water 12. In order to do this in an expedient manner, vessel 16 is equipped with propulsion system 18.

However, as noted above, propulsion system 18 was substantially limited in order to permit material 20 to sink as substantial forward momentum would reduce the ability of material 20 to sink. Thus problem is resolved with cooling system 22 as shown in FIG. 2.

Cooling system 22 comprises pump 24 mechanically coupled to first tank 26 and second tank 26. First tank 26 and second tank 26 are both configured to store material 20. Material 20 can be one or more of a liquid or granular pesticides, a nutrient inactivation, and a water quality improvement compound.

Pump 24 is further mechanically coupled to first cooler 28 and second cooler 28. First cooler 28 utilizes a first heat exchanger. Likewise second cooler 28 utilizes a second heat exchanger. Each heat exchanger can be as simple as a hose passing through a cooled compartment. In some embodiments the cooled compartment can be cooled with dry ice or liquid nitrogen.

First cooler 28 is mechanically coupled to first nozzle 30 which increases the velocity of material 20 such that material 20 is dispersed well clear of vessel 16. Likewise, second cooler 28 is mechanically coupled to second nozzle 30 which increases the velocity of material 20 such that material 20 is dispersed well clear of vessel 16.

A process for dispersing material 20 into vegetation 14 beneath water 12 involves the following steps, which are not necessarily in order. First, loading material 20 into at least one tank 26. Next, pumping material 20 from at least one tank 26 through at least one cooler 28. Wherein, at least one cooler 28 substantially reduces a temperature of material 20. Increasing velocity of material 20 though at least one nozzle 30. Wherein, cooled material 20 is configured to sink rapidly through water 12 even if vessel 16 is traveling at a speed greater than 10 knots.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An aquatic material application system, configured to disperse a material on a vegetation beneath a water; the aquatic material application system comprising:
a vessel, configured to float upon the water;
a propulsion system, attached to the vessel and configured to propel the vessel through the water;
a cooling system, attached to the vessel and configured to pump the material, cool the material creating a cooled material and then dispense the cooled material from the vessel;
wherein the cooled material is configured to sink through the water to contact the vegetation.

2. The aquatic material application system of claim 1, wherein the cooling system further comprises:
a first tank, configured to store the material;
a pump, mechanically coupled to the first tank;
a first cooler mechanically coupled to the pump; and
a first nozzle mechanically coupled to the first cooler;
wherein the pump is configured to move the material from the first tank through the first cooler creating the cooled material which is dispensed through the first nozzle.

3. The aquatic material application system of claim 2, wherein the cooling system further comprises:
a second tank, configured to store the material and mechanically coupled to the pump;
a second cooler mechanically coupled to the pump; and
a second nozzle mechanically coupled to the second cooler;
wherein the pump is configured to move the material from the second tank through the second cooler creating the cooled material which is dispensed through the second nozzle.

4. The aquatic material application system of claim 3, wherein the material includes one of: a liquid or granular pesticides, a nutrient inactivation, and a water quality improvement compound.

5. The aquatic material application system of claim 3, wherein the cooler utilizes dry ice.

6. The aquatic material application system of claim 3, wherein the cooler utilizes liquid nitrogen.

7. A process for dispensing a cooled material onto vegetation beneath a water; the process comprising:
loading a material into at least one tank;
pumping material from the at least one tank through at least one cooler; wherein, the at least one cooler substantially reduces a temperature of the material;
forming a cooled material in the at least one cooler; and
increasing velocity of the cooled material though at least one nozzle;
wherein the cooled material is configured to sink rapidly through the water onto the vegetation.

8. The process of claim 7, wherein the material includes one of: a liquid or granular pesticides, a nutrient inactivation, and a water quality improvement compound.

9. The process of claim 7, wherein the cooler utilizes dry ice.

10. The process of claim 7, wherein the cooler utilizes liquid nitrogen.
